(19) United States
(12) Patent Application Publication
(10) Pub. No.: US 2021/0057866 A1
(43) Pub. Date: Feb. 25, 2021

(54) OPTICAL FIBER AND LASER DEVICE

(71) Applicant: Fujikura Ltd., Tokyo (JP)

(72) Inventors: Rintaro Kitahara, Chiba (JP); Tatsuya Kishi, Chiba (JP)

(73) Assignee: Fujikura Ltd., Tokyo (JP)

(21) Appl. No.: 16/958,374

(22) PCT Filed: Dec. 27, 2018
(86) PCT No.: PCT/JP2018/048371

§ 371 Date: Jun. 26, 2020

(30) Foreign Application Priority Data
Dec. 28, 2017 (JP) 2017-254365

(51) Int. Cl. H01S 3/067; H01S 3/16

(52) U.S. Cl. CPC H01S 3/06716; H01S 3/1618

(57) ABSTRACT

An optical fiber includes a core that propagates a light that includes a wavelength of 1060 nm. The light propagates in the core at least in an LP01 mode and an LP11 mode. A difference Δβ between a propagation constant of the light in the LP01 mode and a propagation constant of the light in the LP11 mode is 2000 rad/m or smaller. The expression

$$L ≦ \frac{Δ {M}^{2}}{- 2372 \times 1 {0}^{- 6} \times Δ β + 4.819 \times 1 {0}^{- 3}}$$

is satisfied, where L is a length, M² is a beam quality of light, ΔM² is a deterioration amount of the beam quality of light due to propagation in the optical fiber.

### TECHNICAL FIELD

The present invention relates to an optical fiber and a laser device using the optical fiber that can suppress deterioration in beam quality to a desired range while suppressing stimulated Raman scattering.

### BACKGROUND

A fiber laser device is used in various field such as a laser machining field and a medical field because the fiber laser device is excellent in light condensing performance, has high power density, and can obtain light that becomes a small beam spot. In such a fiber laser device, power of emitted light is increased. However, when power density of light in an optical fiber increases, wavelength conversion of the light due to the stimulated Raman scattering easily occurs and light having an unintended wavelength is sometimes emitted. In this case, the light reflected on a workpiece or the like returns to the fiber laser device again and is amplified. Consequently, in some case, the amplitude of light has a wavelength that should be amplified in design becomes unstable and an output becomes unstable.

Examples of a method of suppressing the stimulated Raman scattering in the optical fiber include a method of increasing an effective sectional area of light propagating in a core. Examples of a method of increasing the effective sectional area include a method of increasing the diameter of the core and a method of reducing a relative refractive index difference of the core with respect to a clad. When the diameter of the core is increased, since light confining power of the core increases, the optical fiber bends to be converted into a multimode. Therefore, examples of a method of suppressing the light confining power of the core include a method of reducing the relative refractive index difference of the core with respect to the clad. However, when the relative refractive index difference of the core with respect to the clad is reduced, the light propagating in the core is easily affected by a macro bend and a micro bend. Accordingly, it is requested to adjust the relative refractive index difference of the core with respect to the clad while properly increasing the diameter of the core.

However, even when the core is designed as explained above, there is a limit in the size of an effective sectional area of light in an LP01 mode when it is attempted to propagate the light in a single mode. Therefore, it is attempted to increase the effective sectional area of the light in the LP01 mode by configuring a fiber laser device using an optical fiber including a core capable of propagating light in a few modes like an optical fiber described in Patent Literature 1 described below.
[Patent Literature 1] JP2016-51859 A

In a fiber laser device, it is preferable that beam quality of emitted light is excellent from, for example, the viewpoint of light condensing performance. Accordingly, there is a demand for suppressing light in a mode other than a basic mode from being excited even when the effective sectional area of the light in the LP01 mode is increased by using the optical fiber including the core capable of propagating light in the few mode as explained above. Note that the beam quality is indicated by, for example, M² (M square).

### SUMMARY

One or more embodiments of the present invention provide an optical fiber and a laser device using the optical fiber that can suppress deterioration in beam quality to a desired range while suppressing stimulated Raman scattering.

One or more embodiments of the present invention is an optical fiber in which light having at least a wavelength of 1060 nm is capable of propagating in a core at least in an LP01 mode and an LP11 mode, wherein a difference Δβ between a propagation constant of the light in the LP01 mode and a propagation constant of the light in the LP11 mode is 2000 rad/m or smaller and, when a deterioration amount of beam quality of light indicated by M² due to propagation in the optical fiber is represented as ΔM², length L satisfies an expression described below.

$$L ≦ \frac{Δ {M}^{2}}{- 2.372 \times 1 {0}^{- 6} \times Δ β + 4.819 \times 1 {0}^{- 3}}$$

The light having at least the wavelength of 1060 nm propagates in the core at least in the LP01 mode and the LP11 mode and the difference between the propagation constant of the light in the LP01 mode and the propagation constant of the light in the LP11 mode is set to 2000 rad/m or smaller. Therefore, compared with a single-mode fiber, it is possible to increase an effective sectional area of the light in the LP01 mode. Accordingly, it is possible to suppress the stimulated Raman scattering. The present inventors have found that, when the length L of the optical fiber satisfies the above expression, beam quality of emitted light can be suppressed to a desired deterioration amount ΔM² or less. Specifically, the present inventors have found that deterioration in beam quality due to inter-mode combination of light is proportional to the length of the optical fiber and that, when the difference Δβ between the propagation constant of the light in the LP01 mode and the propagation constant of the light in the LP11 mode is 2000 rad/m or smaller, a proportional constant between deterioration in beam quality and the length of the optical fiber is proportional to the propagation constant difference Δβ. Based on this finding, the present inventors have obtained the conclusion that, when the length L of the optical fiber satisfies the condition described above, a deterioration amount of beam quality due to a shift of the light in the LP01 mode to the LP11 mode can be suppressed to ΔM² or less. Therefore, with the optical fiber according to one or more embodiments of the present invention, it is possible to suppress deterioration in beam quality to a desired range while suppressing stimulated Raman scattering.

In one or more embodiments, the deterioration amount ΔM² is 0.05 or less, and may be 0.03 or less.

Since the deterioration amount ΔM² of the beam quality M² due to the propagation in the optical fiber is 0.05 or less, it is possible to emit light excellent in light condensing performance. Since the deterioration amount ΔM² is 0.03 or less, it is possible to emit light more excellent in the light condensing performance.

In one or more embodiments, the length L is 50 m or less.

The length L satisfying the expression described above sometimes exceeds 50 m depending on the difference Δβ between the propagation constant of the light in the LP01 mode and the propagation constant of the light in the LP11 mode. Therefore, even when the propagation constant difference Δβ is a relatively large value, since a maximum of the length L is suppressed to 50 m, it is possible to further suppress the stimulated Raman scattering.

In one or more embodiments, at least ytterbium is added to the core.

When at least ytterbium is added to the core to form an amplification optical fiber, since the amplification optical fiber is used, it is possible to configure a fiber laser device that emits light having at least a wavelength of 1060 nm. Therefore, since such an amplification optical fiber is used, it is possible to configure the fiber laser device that can suppress deterioration in beam quality while suppressing the stimulated Raman scattering.

One or more embodiments of the present invention include a laser device including the optical fiber described in any one of the above descriptions.

With the optical fiber included in the laser device, as explained above, it is possible to suppress deterioration in beam quality to a desired range while suppressing stimulated Raman scattering. Therefore, with such a laser device, compared with a laser device in which only an optical fiber not satisfying the above expression is used, it is possible to emit light with a suppressed wavelength shift and deterioration in beam quality suppressed to the desired range.

As explained above, according to one or more embodiments of the present invention, there is provided an optical fiber and a laser device using the optical fiber that can suppress deterioration in beam quality to a desired range while suppressing stimulated Raman scattering.

### BRIEF DESCRIPTION OF DRAWINGS

FIG. 1 is a diagram illustrating a laser device according to one or more embodiments of the present invention.

FIG. 2 is a diagram illustrating a state of a cross section perpendicular to the longitudinal direction of an amplification optical fiber according to one or more embodiments.

FIG. 3 is a diagram illustrating a state of a cross section perpendicular to the longitudinal direction of a first optical fiber according to one or more embodiments.

FIG. 4 is a simulation diagram illustrating a relation between an effective sectional area of light in an LP01 mode propagating in an optical fiber and the difference between a propagation constant of the light in the LP01 mode and a propagation constant of light in an LP11 mode according to one or more embodiments.

FIG. 5 is a diagram of measurement values illustrating the relation between the effective sectional area of the light in the LP01 mode propagating in the optical fiber and the difference between the propagation constant of the light in the LP01 mode and the propagation constant of light in an LP11 mode according to one or more embodiments.

FIG. 6 is a diagram of measurement values illustrating a relation between a propagation constant difference Δβ between the light in the LP01 mode and the light in the LP11 mode and a deterioration amount ΔM² of beam quality M² due to propagation in the optical fiber according to one or more embodiments.

FIG. 7 is a diagram illustrating, for each difference between the propagation constant of the light in the LP01 mode and the propagation constant of the light in the LP11 mode, a relation between the diameter of a core and a relative refractive index difference of the core with respect to a clad according to one or more embodiments.

FIG. 8 is a diagram of measurement values illustrating a relation between length L of an optical fiber in which a propagation constant difference Δβ between the light in the LP01 mode and the light in the LP11 mode is 1734 rad/m and the difference between beam quality M² of light made incident on the optical fiber and beam quality M² of emitted light according to one or more embodiments.

FIG. 9 is a diagram illustrating a relation between a difference Δβ of a propagation constant and a ratio ΔM²/L illustrated in Table 1 according to one or more embodiments.

FIG. 10 is a diagram illustrating a laser device according to one or more embodiments of the present invention.

FIG. 11 is a diagram illustrating a laser device according to one or more embodiments of the present invention.

### DETAILED DESCRIPTION

An optical fiber and a laser device according to one or more embodiments of the present invention are explained in detail below with reference to the drawings. The embodiments illustrated below are for facilitating understanding of the present invention and are not for limitedly interpreting the present invention. The present invention can be changed and improved without departing from the gist of the present invention. Note that, for easiness of understanding, scales of the figures and scales described in the following explanation are sometimes different.

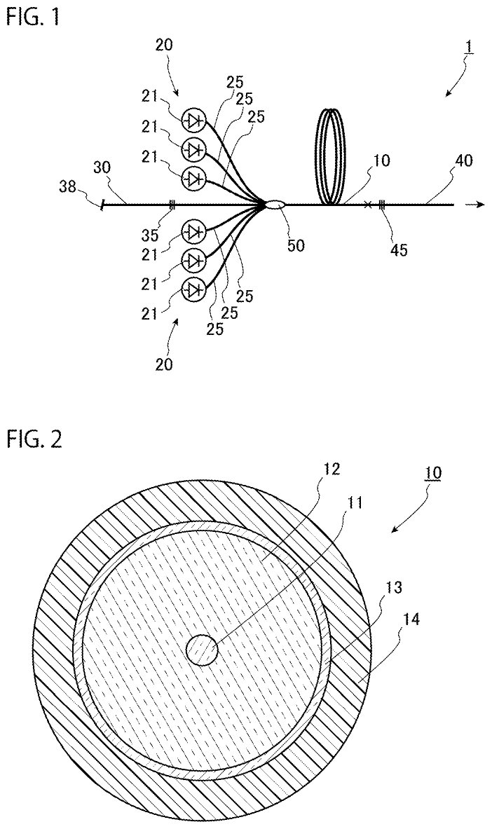

FIG. 1 is a diagram illustrating a laser device according to one or more embodiments. As illustrated in FIG. 1, a laser device 1 of one or more embodiments is a resonator-type fiber laser device. The laser device 1 includes, as main components, an amplification optical fiber 10, a pumping light source 20, a first optical fiber 30, a first FBG 35 provided in the first optical fiber 30, a second optical fiber 40, a second FBG 45 provided in the second optical fiber 40, and an optical combiner 50.

FIG. 2 is a sectional view illustrating the structure of a cross section of the amplification optical fiber 10 illustrated in FIG. 1. As illustrated in FIG. 2, the amplification optical fiber 10 is formed in a so-called double clad structure including, as main components, a core 11, an inner clad 12 surrounding the outer circumferential surface of the core 11 without a gap, an outer clad 13 coating the outer circumferential surface of the inner clad 12, and a coating layer 14 coating the outer clad 13. A refractive index of the inner clad 12 is set lower than a refractive index of the core 11. A refractive index of the outer clad 13 is set lower than the refractive index of the inner clad 12.

The core 11 is made of, for example, quartz added with a dopant such as germanium (Ge) for increasing a refractive index or quartz not added with the dopant for increasing a refractive index. Further, the core 11 is added with at least ytterbium (Yb) pumped by pumping light emitted from the pumping light source 20 as a dopant for amplifying light as explained below. When a refractive index of the core 11 is higher than a refractive index of quartz added with no dopant, the inner clad 12 is made of, for example, the quartz added with no dopant or quartz added with a dopant such as fluorine (F) for reducing a refractive index. When the refractive index of the core 11 is the same as or lower than the refractive index of the quartz added with no dopant, the inner clad 12 is made of the quartz added with the dopant such as fluorine (F) for reducing a refractive index. The outer clad 13 is made of resin or quartz. Examples of the resin include ultraviolet curing resin. Examples of the quartz include quartz added with a dopant such as fluorine (F) for reducing a refractive index to be lower than the refractive index of the inner clad 12. Examples of a material forming the coating layer 14 include ultraviolet curing resin. When the outer clad 13 is made of resin, the ultraviolet curing resin is ultraviolet curing resin different from the resin forming the outer clad.

The amplification optical fiber 10 is a few-mode fiber. When light having at least a wavelength of 1060 nm propagates in the core 11, as the light, light in a high-order mode equal to or higher than a secondary LP mode propagates other than light in an LP01 mode, which is a basic mode. Examples of the light in the high-order mode include light in an LP11 mode, light in an LP21 mode, and light in an LP02 mode.

The pumping light source 20 is configured from a plurality of laser diodes 21. In one or more embodiments, the laser diodes 21 are Fabry-Perrot semiconductor lasers including GaAs semiconductor as a material and emit pumping lights having a center wavelength of 915 nm, for example. The laser diodes 21 of the pumping light source 20 are connected to respective optical fibers 25. The pumping lights emitted from the laser diodes 21 propagate in the optical fibers 25 as, for example, multi-mode light.

The optical fibers 25 are each connected to one end of the amplification optical fiber 10 in the optical combiner 50. Specifically, cores of the optical fibers 25 and the inner clad 12 of the amplification optical fiber 10 are connected such that the cores of the optical fibers 25 are optically combined with the inner clad 12 of the amplification optical fiber 10. Therefore, the pumping lights emitted by the laser diodes 21 are made incident on the inner clad 12 of the amplification optical fiber 10 via the respective optical fibers 25 and propagate mainly in the inner clad 12.

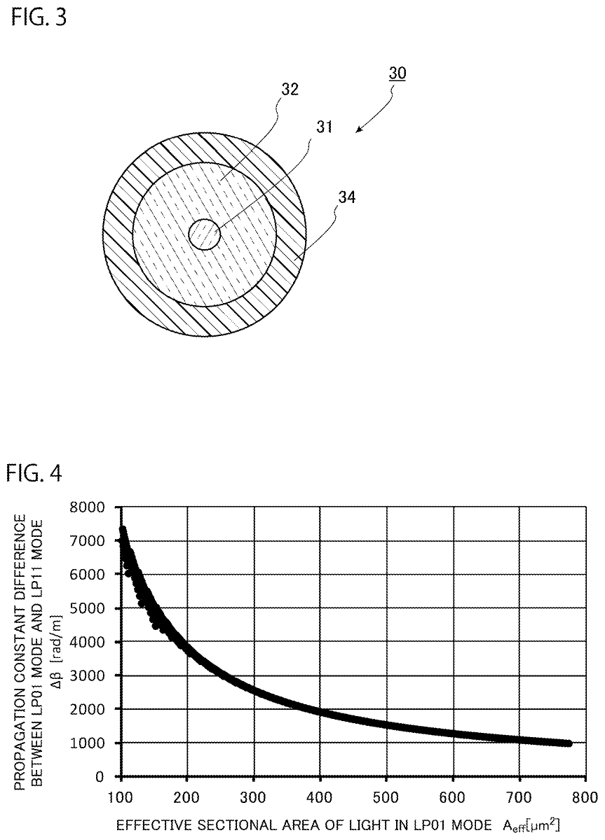

FIG. 3 is a diagram illustrating a state of the first optical fiber 30. The first optical fiber 30 includes, as main components, a core 31, a clad 32 surrounding the outer circumferential surface of the core 31 without a gap, and a coating layer 34 coating the clad 32. The configuration of the core 31 is, for example, set the same as the configuration of the core 11 of the amplification optical fiber 10 except that a rare earth element such as ytterbium is not added. The diameter of the core 31 is set, for example, the same as the diameter of the core 11. The clad 32 is configured, for example, the same as the inner clad 12 except that the diameter of the clad 32 is smaller than the diameter of the inner clad 12 of the amplification optical fiber 10. The coating layer 34 is configured, for example, the same as the configuration of the coating layer 14 of the amplification optical fiber 10.

The first optical fiber 30 is connected to one end of the amplification optical fiber 10 together with the optical fibers 25 in the optical combiner 50. Specifically, the core 11 of the amplification optical fiber 10 and the core 31 of the first optical fiber 30 are connected such that the core 31 of the first optical fiber 30 is optically combined with the core 11 of the amplification optical fiber 10. The first optical fiber 30 is a few-mode fiber and propagates light same as the light propagated by the core 11 of the amplification optical fiber 10. Therefore, lights in the individual LP modes propagating in the core 11 of the amplification optical fiber 10 can directly propagate in the core 31 of the first optical fiber 30.

A photosensitive element such as germanium is added to the core 31 of the first optical fiber 30. This photosensitivity is a characteristic that a refractive index changes when light having a predetermined wavelength is irradiated. The characteristic is used and the first FBG 35 is provided in the core 31 of the first optical fiber 30. In this way, the first FBG 35 is disposed on one side of the amplification optical fiber 10 and is optically combined with the core 11 of the amplification optical fiber 10. In the first FBG 35, a high refractive index portion where a refractive index is higher than a refractive index of portions other than the first FBG 35 of the core 31 and a low refractive index portion where a refractive index is the same as the refractive index of the portions other than the first FBG 35 of the core 31 are cyclically repeated along the longitudinal direction of the core 31. This repetition pattern of the high refractive index portion is formed by, for example, irradiating an ultraviolet ray on a part to be formed as the high refractive index portion. The first FBG formed in this way is configured to reflect light including at least a wavelength of 1060 nm in light emitted in a state in which ytterbium added to the core 11 of the amplification optical fiber 10 is changed to a pumped state. The reflectance of the first FBG 35 is higher than the reflectance of the second FBG 45 explained below. The first FBG 35 reflects, for example, at 99% or more, the light having the wavelength of 1060 nm in the light emitted by the ytterbium.

Note that a terminal section 38 that converts light into heat is provided on the opposite side of a side of the first optical fiber 30 connected to the amplification optical fiber 10.

In the second optical fiber 40, the diameter of a clad is the same as the diameter of the inner clad 12 of the amplification optical fiber 10. The second optical fiber 40 is configured the same as the amplification optical fiber 10 except that a dopant for amplifying light is not added to a core. Therefore, the second optical fiber 40 is the same few-mode fiber as the amplification optical fiber 10. The second optical fiber 40 can propagate the same light as the light propagated by the core 11 of the amplification optical fiber 10. The second optical fiber 40 is connected such that the core 11 of the amplification optical fiber 10 and the core of the second optical fiber 40 are optically combined at the other end of the amplification optical fiber 10. Therefore, light in a few mode propagating in the core 11 of the amplification optical fiber 10 propagates in the core of the second optical fiber 40 while keeping the few modes.

The second FBG 45 is provided in the core of the second optical fiber 40. In this way, the second FBG 45 is disposed on the other side of the amplification optical fiber 10 and optically combined with the core 11 of the amplification optical fiber 10. In the second FBG 45, as in the first FBG 35, a high refractive index portion and a low refractive index portion are cyclically repeated and formed. The second FBG 45 is configured to reflect, at reflectance lower than the reflectance of the first FBG 35, the light including the wavelength of 1060 nm reflected by the first FBG 35. When the light reflected by the first FBG 35 is made incident on the second FBG 45, the second FBG 45 reflects the light at reflectance of, for example, approximately 10%. In this way, a resonator is formed by the first FBG 35, the amplification optical fiber 10, and the second FBG 45. In one or more embodiments, nothing is connected, in particular, to the other end on the opposite side of the amplification optical fiber side of the second optical fiber 40. However, a glass rod or the like may be connected to the other end.

Next, the operation of the laser device 1 is explained.

First, pumping lights are emitted from the respective laser diodes 21 of the pumping light source 20. The pumping lights are made incident on the inner clad 12 of the amplification optical fiber 10 via the optical fibers 25 and propagate mainly in the inner clad 12. The pumping lights propagating in the inner clad 12 pump the ytterbium added to the core 11 when passing through the core 11. The ytterbium changed to a pumped state emits natural emission light in a specific wavelength band. Starting from this natural emission light, the light including the wavelength of 1060 nm reflected in common on the first FBG 35 and the second FBG 45 resonates between the first FBG 35 and the second FBG 45. When the resonating light propagates in the core 11 of the amplification optical fiber 10, the ytterbium in the pumped state causes stimulated emission and the resonating light is amplified. A part of the resonating light is transmitted through the second FBG 45 and emitted from the second optical fiber 40. The laser device 1 changes to a laser oscillation state when a gain and a loss in the resonator including the first FBG 35, the amplification optical fiber 10, and the second FBG 45 are equal. Light having fixed power is emitted from the second optical fiber 40.

Note that most of the light transmitted through the first FBG 35 from the amplification optical fiber 10 side is converted into heat by the terminal section 38 and disappears.

Incidentally, as explained above, the amplification optical fiber 10, the first optical fiber 30, and the second optical fiber 40 are each a few-mode fiber. Therefore, the light resonating between the first FBG 35 and the second FBG and the light transmitted through the second FBG 45 include, besides the light in the basic mode, lights in several high-order modes equal to or higher than the secondary LP mode. Besides the light in the basic mode, the lights in the several high-order modes equal to or higher than the secondary LP mode propagate in the second optical fiber 40 and are emitted from the laser device 1. However, as explained below, in the amplification optical fiber 10, the first optical fiber 30, and the second optical fiber 40, propagation in high-order modes equal to or high than the LP02 mode is reduced. Energy of lights in the LP02 mode or higher modes propagating in the amplification optical fiber 10, the first optical fiber 30, and the second optical fiber 40 is reduced.

A propagation constant of light propagating in a core of an optical fiber is explained. Note that, in the following explanation, when a clad is referred to, the clad means the clad 32 of the first optical fiber 30, the clad of the second optical fiber 40, or the inner clad 12 of the amplification optical fiber 10. The propagation constant is a constant concerning phase fluctuation in the case in which a light wave propagates. Since light is a wave, when the amplitude of the light is represented as A and the distance from the center of the core is represented as z, an electric field E in the core is indicated by Expression (1) described below.

E=A exp[−(α+iβ)z] (1)

Note that α is an extinction coefficient indicating extinction of the wave, β is a propagation constant indicating propagation of the wave, and i is an imaginary number unit. The above Expression (1) can be described for each of the lights in the individual modes propagating in the core. The light in the LP01 mode and the light in the LP11 mode have extinction coefficients α different from each other and have propagation constants β different from each other. Since the propagation constant β indicate the propagation of the wave, specifying the propagation constant β of the light propagating in the core is specifying an effective refractive index n_{eff} of the light propagating in the core. When the wavelength of the light propagating in the core is represented as λ, the effective refractive index n_{eff} can be indicated by Expression (2) described below.

n_{eff}=λβ/2π (2)

Incidentally, an effective sectional area A_{eff} of the light propagating in the core of the optical fiber is a value correlating to the effective refractive index n_{eff} of the light. Therefore, the effective sectional area A_{eff} is considered to be a value correlating to the propagation constant β of the light.

Next, when the difference between a propagation constant of the light in the LP01 mode and a propagation constant of the light in the LP11 mode propagating in the core is represented as Δβ, the propagation constant difference Δβ also correlates with the effective sectional area A_{eff}.

FIG. 4 is a simulation diagram illustrating a relation between the effective sectional area of the light in the LP01 mode having the wavelength of 1060 nm propagating in the optical fiber and the propagation constant difference Δβ between the light in the LP01 mode and the light in the LP11 mode. In the simulation in FIG. 4, a refractive index profile of the core was a refractive index profile fixed in a radial direction, that is, stepwise. In the simulation, the diameter of the core was changed from 10 μm to 40 μm at a 1 μm interval and a relative refractive index difference of the core with respect to the clad was changed from 0.1% to 0.2% at a 0.005% interval. From FIG. 4, it is seen that the propagation constant difference Δβ correlates with the effective sectional area A_{eff} of the light in the LP01 mode as explained above. From FIG. 4, if the propagation constant difference Δβ is 4000 rad/m or smaller, the effective sectional area of the light in the LP01 mode can be increased to 191 μm² or larger. If the effective sectional area of the light in the LP01 mode is 191 μm² or larger, it is possible to reduce energy density of the light and suppress the stimulated Raman scattering from occurring. If the propagation constant difference Δβ is 2500 rad/m or smaller, the effective sectional area of the light in the LP01 mode can be increased to 300 μm² or larger. If the effective sectional area of the light in the LP01 mode is 300 μm² or larger, it is possible to further reduce energy density of the light and further suppress the stimulated Raman scattering from occurring.

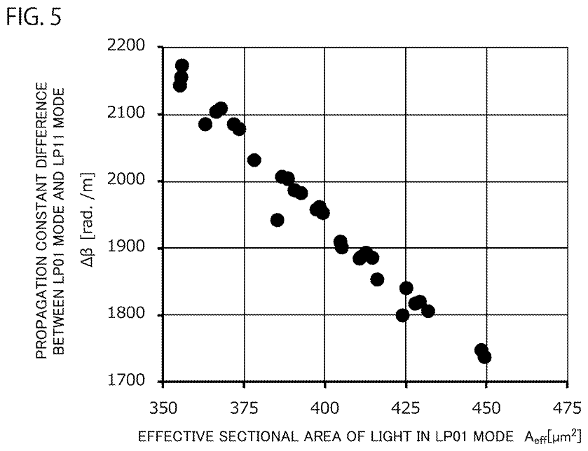

FIG. 5 is a diagram of measurement values indicating a relation between the effective sectional area of the light in the LP01 mode having the wavelength of 1060 nm propagating in the optical fiber and the propagation constant difference Δβ between the light in the LP01 mode and the light in the LP11 mode. In the measured optical fiber, the refractive index profile of the core is stepwise, the diameter of the core is 28 μm, and the relative refractive index difference of the core with respect to the clad is 0.12%. Theoretically, lights in the LP01 mode, the LP11 mode, the LP21 mode, the LP02 mode, an LP31 mode, and an LP12 mode are capable of propagating in the optical fiber at the wavelength of 1060 nm. In the measurement values illustrated in FIG. 5, it is also seen that the propagation constant difference Δβ correlates with the effective sectional area A_{eff} of the light in the LP01 mode as explained above. From FIG. 4 and FIG. 5, if the propagation constant difference Δβ is smaller than 2000 rad/m, the effective sectional area of the light in the LP01 mode can be increased to 390 μm² or larger. If the effective sectional area of the light in the LP01 mode is 390 μm² or larger, it is possible to further reduce the energy density of the light and further suppress the stimulated Raman scattering from occurring. If the propagation constant difference Δβ is smaller than 1850 rad/m, the effective sectional area of the light in the LP01 mode can be increased to larger than 420 μm². If the effective sectional area of the light in the LP01 mode is larger than 420 μm², it is possible to further reduce the energy density of the light and further suppress the stimulated Raman scattering from occurring.

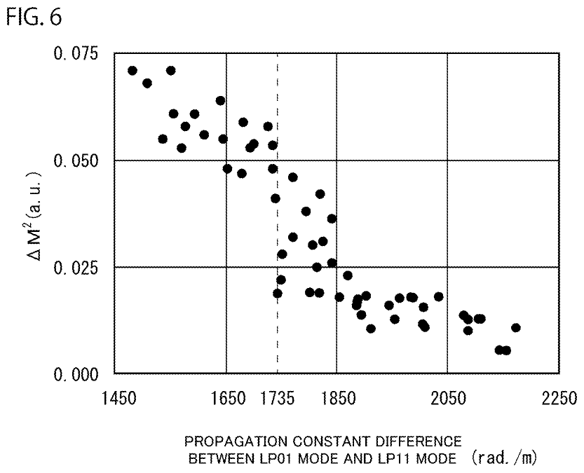

Next, a relation between the propagation constant difference Δβ between the light in the LP01 mode and the light in the LP11 mode and beam quality of light emitted from the optical fiber is explained. FIG. 6 is a diagram of measurement values illustrating a relation between the propagation constant difference Δβ between the light in the LP01 mode and the light in the LP11 mode and a deterioration amount ΔM² of beam quality M² due to propagation in the optical fiber. Measurement in FIG. 6 was performed by, using the optical fiber used in FIG. 5, making the light in the basic mode incident from one end of the optical fiber and measuring M² of light emitted from the other end. Note that the length of this optical fiber is 55 m. The beam quality tends to be deteriorated when the light is made incident on the optical fiber as explained below. A deterioration amount of the beam quality in making the light incident on the optical fiber is subtracted from the measurement value to calculate the deterioration amount ΔM² of the beam quality M² due to the propagation in the optical fiber. In FIG. 6, the deterioration amount ΔM² of the beam quality M² is plotted on the vertical axis. M² of light including only the light in the basic mode is 1. A value of M² is larger as a higher-order mode is excited and the beam quality is further deteriorated. Therefore, a larger deterioration amount ΔM² of the beam quality in FIG. 6 indicates that beam quality of emitted light is further deteriorated. As it is seen from FIG. 6, in this optical fiber, if the propagation constant difference Δβ between the light in the LP01 mode and the light in the LP11 mode is 1735 [rad/m] or more, the deterioration amount ΔM² can be reduced to smaller than 0.05. Satisfactory beam quality can be obtained. If the deterioration amount ΔM² is smaller than 0.05, the optical fiber used in the laser device can emit light having sufficiently satisfactory beam quality. In this way, from FIG. 6, it is seen that, if the propagation constant difference Δβ between the light in the LP01 mode and the light in the LP11 mode is 1735 [rad/m] or more, deterioration in beam quality of light emitted from the optical fiber is suppressed. Note that, in the optical fiber having this length, when the propagation constant difference Δβ is 1850 [rad/m] or more, the deterioration amount ΔM² can be reduced to smaller than 0.025. The beam quality is more satisfactory. Therefore, it is seen that, if the propagation constant difference Δβ between the light in the LP01 mode and the light in the LP11 mode is 1850 [rad/m] or more, the deterioration in the beam quality of the light emitted from the optical fiber is further suppressed.

Next, a relation among the diameter of the core, a relative refractive index difference Δn of the core with respect to the clad, and the propagation constant difference Δβ between the light in the LP01 mode and the light in the LP11 mode is explained. When the refractive index of the core is represented as n₁ and the refractive index of the clad is represented as n₂, the relative refractive index difference Δn of the core with respect to the clad is indicated by Expression (3) described below.

Δn=(n₁²−n₂²)/(2n₁²) (3)

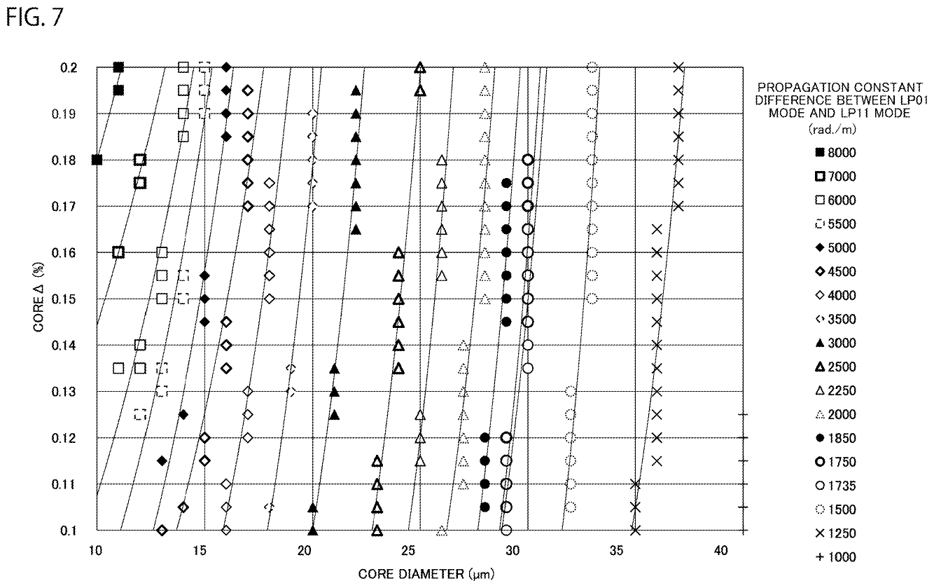

FIG. 7 is a diagram illustrating, for each propagation constant difference Δβ between the light in the LP01 mode and the light in the LP11 mode, in a simulation, a relation between the diameter of the core and the relative refractive index difference Δn of the core with respect to the clad. Note that, in the figure as well, a refractive index profile of the core is fixed in the radial direction, that is, stepwise. As illustrated in FIG. 7, if the core diameter and the relative refractive index difference Δn are satisfied to be present in a region further on the right side than any line indicating the propagation constant difference Δβ between the light in the LP01 mode and the light in the LP11 mode, it is considered possible to reduce a propagation constant difference to the propagation constant difference Δβ or less. As an example, as illustrated in FIG. 7, for example, when the relative refractive index difference Δn is 0.10, if the diameter of the core is 16 μm or larger, the propagation constant difference Δβ can be reduced to 4000 rad/m or smaller. That is, when FIG. 4 is considered, if the diameter of the core is 16 μm or larger, the effective sectional area of the light in the LP01 mode can be increased to 191 μm² or larger. As illustrated in FIG. 7, it is seen that, for example, when the relative refractive index difference Δn is 0.10, if the diameter of the core is 23 μm or larger, the propagation constant difference Δβ can be reduced to 2500 rad/m or smaller. When FIG. 4 is considered, if the diameter of the core is 23 μm or larger, the effective sectional area of the light in the LP01 mode can be increased to 300 μm² or larger. As illustrated in FIG. 7, it is seen that, for example, when the relative refractive index difference Δn is 0.10, if the diameter of the core is 27.5 μm or larger, the propagation constant difference Δβ can be reduced to 2000 rad/m or smaller. That is, when FIGS. 4 and 5 are considered, if the diameter of the core is larger than 27.5 μm, the effective sectional area of the light in the LP01 mode can be increased to larger than 390 μm². As illustrated in FIG. 7, it is seen that, for example, when the relative refractive index difference Δn is 0.10, if the diameter of the core is larger than 28 μm, the propagation constant difference Δβ can be reduced to smaller than 1850 rad/m. That is, when FIGS. 4 and 5 are considered, if the diameter of the core is larger than 28 μm, the effective sectional area of the light in the LP01 mode can be increased to larger than 420 μm².

As illustrated in FIG. 7, it is seen that, for example, when the relative refractive index difference Δn is 0.10, if the diameter of the core is 29.0 μm or smaller, the propagation constant difference Δβ can be increased to 1735 rad/m or larger. That is, in the optical fiber having the length used in FIG. 6, when FIG. 6 is considered, if the diameter of the core is 29.0 μm or smaller, the deterioration amount ΔM² can be reduced to less than 0.05 and the deterioration in the beam quality of the light emitted from the optical fiber can be suppressed. Further, as illustrated in FIG. 7, it is seen that, if the diameter of the core is 28 μm or smaller, the propagation constant difference Δβ can be increased to 1850 rad/m or larger. That is, in the optical fiber having the length used in FIG. 6, when FIG. 6 is considered, if the diameter of the core is 28 μm or smaller, the deterioration amount ΔM² can be reduced to less than 0.025 and the deterioration in the beam quality of the light emitted from the optical fiber can be further suppressed.

In this way, in the optical fiber that propagates the light having the wavelength of 1060 nm, if the propagation constant difference Δβ between the light in the LP01 mode and the light in the LP11 mode propagating in the optical fiber is 4000 rad/m or smaller, it is possible to suppress the stimulated Raman scattering from occurring. If the propagation constant difference Δβ is 2500 rad/m or smaller, it is possible to further suppress the stimulated Raman scattering from occurring. If the propagation constant difference Δβ is 2000 rad/m or smaller, it is possible to still further suppress the stimulated Raman scattering from occurring. If the propagation constant difference Δβ is smaller than 1850 rad/m, it is possible to yet still further suppress the stimulated Raman scattering from occurring. On the other hand, in the case of the length of the optical fiber used for explanation referring to FIG. 6, if the propagation constant difference Δβ between the light in the LP01 mode and the light in the LP11 mode propagating in the optical fiber is 1735 rad/m or larger, the deterioration in the beam quality of the light emitted from the optical fiber is suppressed. If the propagation constant difference Δβ is 1850 rad/m or larger, the deterioration in the beam quality of the light emitted from the optical fiber is further suppressed.

Therefore, in the laser device 1, if the propagation constant difference Δβ between the light in the LP01 mode and the light in the LP11 mode propagating in the amplification optical fiber 10, the first optical fiber 30, and the second optical fiber 40 is 4000 rad/m or smaller, it is possible to suppress the stimulated Raman scattering from occurring. If the propagation constant difference Δβ is 2500 rad/m or smaller, it is possible to further suppress the stimulated Raman scattering from occurring. If the propagation constant difference Δβ is 2000 rad/m or smaller, it is possible to still further suppress the stimulated Raman scattering from occurring. If the propagation constant difference Δβ is smaller than 1850 rad/m, it is possible to yet still further suppress the stimulated Raman scattering from occurring. On the other hand, when the amplification optical fiber 10, the first optical fiber 30, and the second optical fiber 40 respectively have the length of the optical fiber used for the explanation referring to FIG. 6, if the propagation constant difference Δβ between the light in the LP01 mode and the light in the LP11 mode propagating in the amplification optical fiber 10, the first optical fiber 30, and the second optical fiber 40 is 1735 rad/m or larger, the deterioration in the beam quality of the light is suppressed in the respective optical fibers. If the propagation constant difference Δβ is 1850 rad/m or larger, the deterioration in the beam quality of the light in the respective optical fibers is further suppressed. It is possible to suppress the deterioration in the beam quality of the beam emitted from the laser device 1.

Next, a relation between beam quality and the length of an optical fiber is explained.

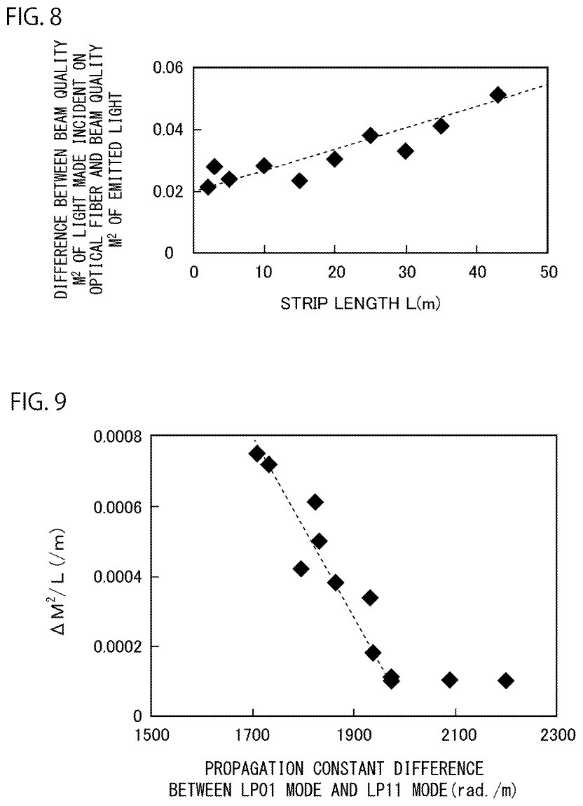

FIG. 8 is a diagram of measurement values illustrating a relation between length L of an optical fiber in which the propagation constant difference Δβ between the light in the LP01 mode and the light in the LP11 mode is 1734 rad/m and the difference between the beam quality M² of light made incident on the optical fiber and the beam quality M² of emitted light. A deterioration amount illustrated in FIG. 8 is a result obtained by reducing the length of the optical fiber from 43 m to 2 m and measuring, at the respective lengths, a deterioration amount with the same method as the measurement of the deterioration amount in FIG. 6. Note that a difference in the beam quality illustrated in FIG. 6 is a sum of a deterioration amount at the time when light is made incident on the optical fiber and a deterioration amount of beam quality due to propagation of the light in the optical fiber. Therefore, a value of a deterioration amount at the time when the length L is 0 in FIG. 8 is a deterioration amount of the beam quality M² at the time when light is made incident on the optical fiber. In FIG. 8, an example in which a deterioration amount of the beam quality M² at the time when light is made incident on the optical fiber is approximately 0.02 is illustrated. As illustrated in FIG. 8, it is seen that the deterioration amount of the beam quality of the light increases in a linear function manner with respect to the length L of the optical fiber. In the case of FIG. 8, it is seen that the deterioration amount ΔM² of light generated when propagating in the optical fiber is calculated by subtracting approximately 0.02 from a value of the vertical axis and the deterioration amount ΔM² of the beam quality M² of the light due to propagation in the optical fiber increases in proportion to the length of the optical fiber. Note that the deterioration amount of the beam quality M² at the time when the light is made incident on the optical fiber is, for example, when an optical fiber, in which a deterioration amount of beam quality of light propagating in the optical fiber is measured, is connected to an optical fiber for input in which light in a single mode propagates, an amount due to deterioration by connection of these optical fibers.

A relation between the propagation constant difference Δβ and a ratio of the length L of an optical fiber and the deterioration amount ΔM² of beam quality due to propagation in the optical fiber is checked using a plurality of optical fibers having different propagation constant differences Δβ between the light in the LP01 mode and the light in the LP11 mode. The ratio is indicated by ΔM²/L. The propagation constant differences Δβ of samples 1 to 12 of the optical fibers used for the measurement and the ratio ΔM²/L between the length L and the deterioration amount ΔM² are illustrated in Table 1 below.

TABLE 1

| | Δ β | ΔM²/L |
|---|---|---|
| Sample 1 | 1733.76 | 0.00072 |
| Sample 2 | 2088.92 | 0.00010 |
| Sample 3 | 1825.94 | 0.00061 |
| Sample 4 | 1932.45 | 0.00034 |
| Sample 5 | 1865.30 | 0.00038 |
| Sample 6 | 1797.54 | 0.00042 |
| Sample 7 | 1710.83 | 0.00075 |
| Sample 8 | 1973.44 | 0.00010 |
| Sample 9 | 1973.44 | 0.00011 |
| Sample 10 | 1938.42 | 0.00018 |
| Sample 11 | 1832.96 | 0.00050 |
| Sample 12 | 2200.00 | 0.00010 |

FIG. 9 is a diagram illustrating a relation between the propagation constant difference Δβ and the ratio ΔM²/L illustrated in Table 1. As illustrated in FIG. 9, in a region where the propagation constant difference Δβ between the light in the LP01 mode and the light in the LP11 mode is larger than 2000 rad/m, as a result, the ratio ΔM²/L is generally fixed. On the other hand, it is seen that, in a region where the propagation constant difference Δβ is 2000 rad/m or smaller, the ratio ΔM²/L increases as the propagation constant difference Δβ decreases. As explained with reference to FIG. 8, the deterioration amount ΔM² of the beam quality of the light due to propagation in the optical fiber increases in proportion to the length L of the optical fiber. Therefore, from FIG. 9, when the propagation constant difference Δβ is 2000 rad/m or smaller, as the propagation constant difference Δβ decreases, a gradient of a straight line indicating the relation between length L of the optical fiber and the difference between the beam quality M² of the incident light and the beam quality M² of the emitted light illustrated in FIG. 8 increases. Therefore, it is seen that, when the propagation constant difference Δβ is 2000 rad/m or smaller, as the propagation constant difference Δβ is smaller, the deterioration amount ΔM² of the beam quality increases at the short length L.

Accordingly, when the propagation constant difference Δβ is 2000 rad/m or smaller, an optical fiber having an appropriate length needs to be used in order to suppress deterioration in beam quality.

Next, the length L of the optical fiber for suppressing deterioration in beam quality is explained.

When linear approximation is performed by a method of least squares in the region where the propagation constant difference Δβ is 2000 rad/m or smaller in FIG. 9, a gradient is −2.372×10⁻⁶ and an intercept is 4.819×10⁻³. Therefore, this straight line in the region where the propagation constant difference Δβ is 2000 rad/m or smaller can be represented by the following Expression (4).

ΔM²/L=−2.372×10⁻⁶×Δβ+4.819×10⁻³ (4)

Therefore, in the region where the propagation constant difference Δβ is 2000 rad/m or smaller, if the length L satisfies Expression (5) described below, a deterioration amount of beam quality due to propagation in the optical fiber can be reduced to ΔM² or less.

$$L ≦ \frac{Δ {M}^{2}}{- 2.372 \times 1 {0}^{- 6} \times Δ β + 4.819 \times 1 {0}^{- 3}} \qquad ( 5 )$$

In one or more embodiments, as explained with reference to FIG. 6 and from the viewpoint of obtaining satisfactory beam quality, the deterioration amount ΔM² of the beam quality due to propagation in the optical fiber is 0.05 or less. In one or more embodiments, in Expression (5) described above, the deterioration amount ΔM² is 0.05 or less and may be 0.03 or less from the viewpoint of emitting light having more excellent beam quality. For example, if the deterioration amount ΔM² is 0.05 or less, as explained with reference to FIG. 8, when the deterioration amount of the light at the time when the light is made incident on the optical fiber is approximately 0.02, the difference between the beam quality of the light before being made incident on the optical fiber and the beam quality of the light emitted from the optical fiber can be suppressed to approximately 0.07 or less. If the deterioration amount is approximately 0.07, the influence on light condensing performance can be suppressed. The beam quality is sufficiently high for light used in the laser device. As explained above, if the deterioration amount ΔM² is 0.03 or less, when the deterioration amount of the light at the time when the light is made incident on the optical fiber is approximately 0.02, the difference between the beam quality of the light before being made incident on the optical fiber and the beam quality of the light emitted from the optical fiber can be suppressed to approximately 0.05. Light more excellent in the light condensing performance can be emitted.

As explained above, when the propagation constant difference Δβ is 2000 rad/m or smaller, the effective sectional area of the light in the LP01 mode can be increased to 390 μm² or more. Therefore, if the length L satisfies Expression (5) described above when the propagation constant difference Δβ is 2000 rad/m or smaller, it is possible to suppress deterioration in beam quality while suppressing the stimulated Raman scattering.

In one or more embodiments, at least one of the amplification optical fiber 10, the first optical fiber 30, and the second optical fiber 40 used in the laser device 1 satisfies Expression (5) described above. In one or more embodiments, each of the amplification optical fiber 10, the first optical fiber 30, and the second optical fiber 40 satisfies Expression (5) described above. In one or more embodiments, the length of a section sandwiched by the first FBG 35 and the second FBG 45 in the amplification optical fiber 10, the first optical fiber 30, and the second optical fiber 40 satisfies Expression (5) described above. In one or more embodiments, a total length of the amplification optical fiber 10, the first optical fiber 30, and the second optical fiber 40 satisfies Expression (5) described above. In these cases as well, the deterioration amount ΔM² is 0.05 or less and may be 0.03 or less.

Incidentally, when the right side of Expression (5) described above is calculated, when the deterioration amount ΔM² is 0.05, the right side exceeds 50 m between 1610.03 rad/m and 1610.04 rad/m of the propagation constant difference Δβ between the light in the LP01 mode and the light in the LP11 mode. When the right side of Expression (5) above is calculated, when the deterioration amount ΔM² is 0.03, the right side exceeds 50 m between 1778.66 rad/m and 1778.67 rad/m of the propagation constant difference Δβ between the light in the LP01 mode and the light in the LP11 mode. In the laser device, the optical fiber is not often used exceeding 50 m. In one or more embodiments, the length L satisfies Expression (5) described above and is 50 m or less. Since a maximum of the length L is suppressed to 50 m, it is possible to further suppress the stimulated Raman scattering.

In one or more embodiments, in the laser device 1, for example, a maximum of the length L of at least one of the amplification optical fiber 10, the first optical fiber 30, and the second optical fiber 40 is suppressed to 50 m or less. In one or more embodiments, a maximum of the length L of each of the amplification optical fiber 10, the first optical fiber 30, and the second optical fiber 40 is suppressed to 50 m or less. In one or more embodiments, a maximum of the length L of a section sandwiched by the first FBG 35 and the second FBG 45 in the amplification optical fiber 10, the first optical fiber 30, and the second optical fiber 40 is suppressed to 50 m or less. In one or more embodiments, a maximum of a total length L of the amplification optical fiber 10, the first optical fiber 30, and the second optical fiber 40 is suppressed to 50 m or less.

Note that, in the laser device 1, as explained above, the first optical fiber 30, in which the first FBG 35 is formed, is connected to one end of the amplification optical fiber 10. The second optical fiber 40, in which the second FBG 45 is formed, is connected to the other end of the amplification optical fiber 10. Therefore, from the viewpoint of being capable of suppressing deterioration in beam quality at a connection point of the optical fiber, an electric field profile calculated from a refractive index profile of the amplification optical fiber 10 and an electric field profile calculated from a refractive index profile of the first optical fiber 30 are approximate to each other in one or more embodiments. In one or more embodiments, the electric field profile calculated from the refractive index profile of the amplification optical fiber 10 and an electric field profile calculated from a refractive index profile of the second optical fiber 40 are approximate to each other. For example, if combination efficiency a, defined by Expression (6) described below is 0.995 or more, it is possible to suppress deterioration in the beam quality M² at a connection point of the amplification optical fiber 10 and the first optical fiber 30 or the second optical fiber 40 to approximately 0.02.

$${α}_{e} = {( {\int }_{0}^{∞} \frac{{E}_{A} ( r ) {E}_{P} ( r )}{\sqrt{{\int }_{0}^{∞} {E}_{A} ( r ) dr {\int }_{0}^{∞} {E}_{P} ( r ) dr}} d r )}^{2} \qquad ( 6 )$$

Note that r in Expression (6) described above indicates a distance in the radial direction from the center axis of the optical fiber, E_{A}(r) indicates an electric field profile in the radial direction of the amplification optical fiber 10, and E_{P}(r) indicates an electric field profile in the radial direction of the first optical fiber 30 or the second optical fiber 40.

As explained above, at least one of the amplification optical fiber 10, the first optical fiber 30, and the second optical fiber 40 used in the laser device 1 of one or more embodiments is an optical fiber in which light having at least the wavelength of 1060 nm is capable of propagating in the core at least in the LP01 mode and the LP11 mode. By satisfying Expression (5) described above, it is possible to suppress deterioration in beam quality while suppressing the stimulated Raman scattering.

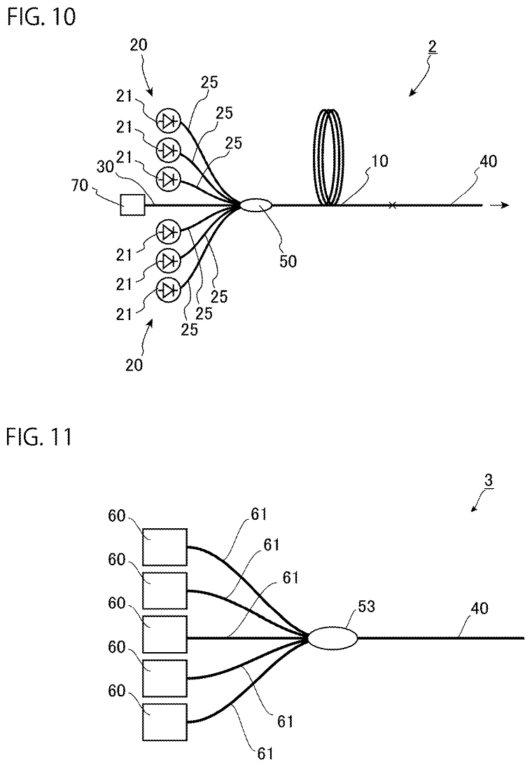

Next, embodiments of the present invention will be explained in detail below with reference to FIG. 10. Note that components same as or equivalent to the components in the above-described embodiments are denoted by the same reference numerals and signs and explanation of the components is omitted except when the components are particularly explained.

FIG. 10 is a diagram illustrating a laser device according to one or more embodiments. As illustrated in FIG. 10, a laser device 2 of one or more embodiments is different from the laser device 1 in the above-described embodiments in that the laser device 2 is a fiber laser device of an MO-PA (Master Oscillator Power Amplifier) type. Therefore, the laser device 2 in one or more embodiments includes a seed light source 70.

The seed light source 70 includes, for example, a laser diode or a fiber laser and is configured to emit seed light having a wavelength of 1060 nm. The seed light source 70 is configured the same as the first optical fiber 30 in the above-described embodiments and connected to the first optical fiber 30 in which an FBG is not formed. The seed light emitted from the seed light source 70 propagates in a core of the first optical fiber 30.

An optical combiner 50 in one or more embodiments is configured the same as the optical combiner 50 in the above-described embodiments. Therefore, the seed light emitted from the seed light source 70 is made incident on a core 31 of an amplification optical fiber 10 via the core of the first optical fiber 30 and propagates in the core 31. As in the laser device 1 in the above-described embodiments, pumping lights emitted from respective laser diodes 21 of a pumping light source 20 are made incident on an inner clad 12 of the amplification optical fiber 10, propagates mainly in the inner clad 12, and pumps ytterbium added to the core 11. Accordingly, the seed light propagating in the core is amplified by stimulated emission of ytterbium changed to a pumped state. The amplified seed light is emitted from the amplification optical fiber 10 as output light. The light emitted from the amplification optical fiber 10 is emitted via a second optical fiber 40 as in the above-described embodiments.

In one or more embodiments, at least one of the amplification optical fiber 10, the first optical fiber 30, and the second optical fiber 40 used in the laser device 2 satisfies Expression (5) described above. In one or more embodiments, a total length of the amplification optical fiber 10, the first optical fiber 30, and the second optical fiber 40 satisfies Expression (5) described above. In these cases as well, the deterioration amount ΔM² is 0.05 or less and may be 0.03 or less. Therefore, in the laser device in one or more embodiments, in an optical fiber satisfying Expression (5) described above, it is possible to suppress deterioration in beam quality to a desired range while suppressing deterioration in beam quality of emitted light. Note that, in one or more embodiments, a dopant is not added to the core of the second optical fiber 40 because a threshold for optical breakage can be increased.

In one or more embodiments, a maximum of the length L of each of the amplification optical fiber 10, the first optical fiber 30, and the second optical fiber 40 is suppressed to 50 m. In one or more embodiments, a maximum of a total length L of the amplification optical fiber 10, the first optical fiber 30, and the second optical fiber 40 is suppressed to 50 m.

Next, embodiments of the present invention will be explained in detail with reference to FIG. 11. Note that components same as or equivalent to the components in the above-described embodiments are denoted by the same reference numerals and signs and explanation of the components is omitted except when the components are particularly explained.

FIG. 11 is a diagram illustrating a laser device according to one or more embodiments. As illustrated in FIG. 11, a laser device 3 in one or more embodiments includes, as main components, a plurality of light sources 60, an optical combiner 53, and a second optical fiber 40 same as the second optical fiber in the above-described embodiments. Note that, in one or more embodiments, a dopant is not added to a core of the second optical fiber 40 because a threshold for optical breakage can be increased.

The respective light sources 60 are configured as laser devices that emit lights having a wavelength of 1060 nm and configured as, for example, fiber laser devices or solid-state laser devices. When the light sources 60 are configured as the fiber laser devices, the light sources 60 are configured as fiber laser devices of a resonator type same as the fiber laser device in the above-described embodiments or configured as fiber laser devices of an MO-PA type same as the fiber laser device in the other above-described embodiments.

Optical fibers 61, which propagate the lights emitted from the light sources 60, are connected to the respective light sources 60. The respective optical fibers 61 are the same as, for example, the first optical fiber 30 in the above-described embodiments. Therefore, the lights emitted from the respective light sources 60 propagate in the respective optical fibers 61 in a few modes.

The optical combiner 53 optically connects cores of the respective optical fibers 61 and a core of the second optical fiber 40.

In the laser device 3 of one or more embodiments, the lights having the wavelength of 1060 nm are emitted from the respective light sources 60. The lights are made incident on the core of the second optical fiber 40 via the respective optical fibers 61 and via the optical combiner 53. The lights are emitted from the second optical fiber 40.

In one or more embodiments, in the second optical fiber used in the laser device 3, the light having the wavelength of 1060 nm is capable of propagating in the core at least in an LP01 mode and an LP11 mode. Expression (5) described above is satisfied. Further, in one or more embodiments, a deterioration amount ΔM² is 0.05 or less and may be 0.03 or less. Therefore, in the laser device of one or more embodiments, in an optical fiber satisfying Expression (5) described above, it is possible to suppress deterioration in beam quality to a desired range while suppressing deterioration in beam quality of emitted light.

In one or more embodiments, a maximum of respective length Ls of the second optical fiber 40 is suppressed to 50 m.

The present invention is explained above using the embodiments as examples. However, the present invention is not limited to the embodiments. The configurations can be changed as appropriate. That is, the optical fiber according to one or more embodiments of the present invention only has to be an optical fiber in which light having a wavelength of 1060 nm is capable of propagating in a core at least in the LP01 mode and the LP11 mode and that satisfies Expression (5) described above. The other configurations can be changed as appropriate.

The optical fiber according to one or more embodiments of the present invention may be used in the laser device as explained above but may be used in a device other than the laser device such as an optical amplifier.

As explained above, according to one or more embodiments of the present invention, the optical fiber and the laser device that can suppress deterioration in beam quality to a predetermined range while suppressing stimulated Raman scattering are provided. Use in a laser device and the like for machining is expected.

Although the disclosure has been described with respect to only a limited number of embodiments, those skilled in the art, having benefit of this disclosure, will appreciate that various other embodiments may be devised without departing from the scope of the present invention.

Accordingly, the scope of the invention should be limited only by the attached claims.

### REFERENCE SIGNS LIST

1, 2, 3 . . . laser device
10 . . . amplification optical fiber
20 . . . pumping light source
30 . . . first optical fiber
31 . . . core
35 . . . first FBG
40 . . . second optical fiber
45 . . . second FBG
60 . . . light source
70 . . . seed light source

1. An optical fiber comprising:
a core that propagates a light that includes a wavelength of 1060 nm, wherein
the light propagates in the core at least in an LP01 mode and an LP11 mode,
a difference Δβ between a propagation constant of the light in the LP01 mode and a propagation constant of the light in the LP11 mode is 2000 rad/m or smaller, and
Expression (5) is satisfied
$$L ≦ \frac{Δ {M}^{2}}{- 2.372 \times 1 {0}^{- 6} \times Δ β + 4 .819 \times {10}^{- 3}} . \qquad ( 5 )$$
where L is a length, M² is a beam quality of light, ΔM² is a deterioration amount of the beam quality of light due to propagation in the optical fiber.

2. The optical fiber according to claim 1, wherein
the deterioration amount ΔM² is 0.05 or less.

3. The optical fiber according to claim 2, wherein
the deterioration amount ΔM² is 0.03 or less.

4. The optical fiber according to claim 1, wherein
the length L is 50 m or less.

5. The optical fiber according to claim 1, wherein ytterbium is added to the core.

6. A laser device comprising
the optical fiber according to claim 1.
